(19) United States
(12) Patent Application Publication
(10) Pub. No.: US 2016/0301755 A1
(43) Pub. Date: Oct. 13, 2016

(54) METHOD AND APPARATUS FOR CONTROLLING SCAN OF SLAVE DEVICES

(71) Applicant: INTER. M CORPORATION, Yangju-si (KR)

(72) Inventors: Seung Jun LEE, Gyeonggi-do (KR); Sug Chin SAKONG, Gyeonggi-do (KR)

(73) Assignee: INTER. M CORPORATION, Yangju-si (KR)

(21) Appl. No.: 14/712,099

(22) Filed: May 14, 2015

(30) Foreign Application Priority Data
Apr. 8, 2015 (KR) 10-2015-0049405

(51) Int. Cl. H04L 29/08; H04L 12/24; H04L 5/00

(52) U.S. Cl. CPC H04L 67/125; H04L 5/0055; H04L 41/12

(57) ABSTRACT

A method for controlling scan of slave devices, comprising: requesting, by a master, each slave to provide its device feature information; acquiring the device feature information provided by each slave in response to the request; sending, by a master, the acquired device feature information to the relevant slave to request the slave to confirm the information; registering the device feature information of the slave having sent an acknowledgement for the confirmation request as base information of the relevant slave; and repeating a scan process performing the above operations described above for each slave predefined N times.

### FIELD OF THE INVENTION

The present invention relates to a method for controlling scan of slave devices, and more particularly to a method and an apparatus for controlling scan of slave devices adapted for collecting information about the number of slave devices and features thereof according to user's scan command while a master device is in an operation mode.

(Korean Government-funded Project Title: Development of i-AVB System Technology for Bidirectional Real-time Transmission and Control of HD Media)

### BACKGROUND OF THE INVENTION

As well known, devices that use a network, for example, office automation systems, industrial control applications and PA systems to interwork with other devices are classified into one or N (for example, 2, 3, etc.) master device(s) and a plurality of slave devices of which the tasks are managed and controlled by the master device.

To this end, each master device collects information about features of each slave device, for example, slave IP, MAC, device ID, and the current state of the slave device, from the slave device.

That is, the master device requests each slave device to send its feature information, and the slave device sends its feature information to the master device to respond to the request. In this conventional way of request and respond, it is common that unstable networks or processing loads of the master device contribute to losing packets. Such a packet loss also contributes to frequent fails in acquiring device feature information.

### SUMMARY OF THE INVENTION

In view of the above, the present invention provides a method for controlling scan of slave devices adapted for acquiring device feature information from each slave device through multiplexed scan while a master device is in an operation mode.

The foregoing problem of the present invention is not limited thereto, and other problems that are not described as above will be apparent to those skilled in the art from the following detailed description.

In accordance with an embodiment of the present invention, there is provided a method for controlling scan of slave devices, comprising: requesting, by a master, each slave to provide its device feature information; acquiring the device feature information provided by each slave in response to the request; sending, by a master, the acquired device feature information to the relevant slave to request the slave to confirm the information; registering the device feature information of the slave having sent an acknowledgement for the confirmation request as base information of the relevant slave; and repeating a scan process performing the above operations described above for each slave predefined N times, wherein the slave providing device feature information to the master during a subsequent scan after a first scan is a slave having not provided device feature information during the first scan, or not sent an acknowledgement for the confirmation request.

In the embodiment, said requesting each slave to provide its device feature information comprises requesting each slave to provide its device feature information when a scan command is received from a user while the master is in an operation mode.

In the embodiment, the request for device feature information is sent to the each slave in a broadcast or multicast manner.

In the embodiment, the slave having sent the acknowledgement to the master changes its own state to a confirmed state.

In the embodiment, the device feature information is sent from the each slave to the master in a unicast manner.

In accordance with an embodiment of the present invention, there is provided an apparatus for controlling scan of slave devices, which comprises: a request protocol creation unit for creating and sending a request protocol for acquiring device feature information to each slave; an information confirmation request unit for sending the acquired device feature information to a relevant slave to request confirmation when the device feature information is acquired from the each slave in response to the request protocol; a feature information management unit for storing the device feature information of the slave for which an acknowledgement for the confirmation request is received in a memory as base information of the relevant slave; and a control unit for controlling a scan process by using the request protocol to repeat the scan process as many as predefined N times, wherein the slave providing device feature information to a master during a subsequent scan after a first scan is a slave having not provided device feature information during the first scan, or not sent an acknowledgement for the confirmation request.

In the embodiment, the request protocol creation unit creates and sends the request protocol to the each slave when a scan command is received from a user while the master is in an operation mode.

In the embodiment, the request protocol is sent to the each slave in a broadcast or multicast manner.

In the embodiment, the slave having sent the acknowledgement to the master changes its own state to a confirmed state.

In the embodiment, the device feature information is sent in a unicast manner and received by the information confirmation request unit.

In accordance with an embodiment of the present invention, there is provided a method for controlling scan of slave devices, comprising: requesting, by a master, each slave to provide its device feature information; sending, by each slave, its device feature information to the master in response to the request; sending, by a master, the acquired device feature information to the relevant slave to request confirmation; changing, by each slave, its own state to a confirmed state after creating and sending an acknowledgement for the confirmation request to the master; registering, by a master, the device feature information of the slave for which the acknowledgement for the confirmation request is received as base information of the relevant slave; and repeating, by a master, scan operation from the step 1 to the step 5 for each slave as many as predefined N times, wherein the slave providing device feature information to the master during a subsequent scan after a first scan is a slave having not provided device feature information during the first scan, or not sent an acknowledgement for the confirmation request.

In the embodiment, the request for device feature information is sent to the each slave in a broadcast or multicast manner.

In the embodiment, the each slave sends the device feature information to the master in response to the request in a unicast manner.

In accordance with an embodiment of the present invention, there is provided an apparatus for controlling scan of slave devices, which comprises: a master configured to repeat a scan process as many as predefined N times by operations of: requesting each slave to provide device feature information; sending the received device feature information to a relevant slave when the device feature information is received to request confirmation; and registering the device feature information of the relevant slave as base information of the relevant slave when an acknowledgement for the confirmation request is received; and at least one or more slaves configured to: provide, in response to the request, the device feature information to the master; create an acknowledgement for the confirmation request to be sent to the master; and change its own state to a confirmed state after sending the acknowledgement, wherein the slave providing device feature information to the master during a subsequent scan after a first scan is a slave having not provided device feature information during the first scan, or not sent an acknowledgement for the confirmation request.

In the embodiment, the master sends the request protocol to the each slave in a broadcast or multicast manner.

In the embodiment, the at least one slave sends the device feature information to the master in a unicast manner.

As described above, according to the present invention, feature information for the slave devices may be acquired from each slave device through multiplexed scan while a master device is in an operation mode, thereby effectively avoiding fails in acquiring the device feature information due to packet loss resulting from unstable networks or processing loads of the master device.

### BRIEF DESCRIPTION OF THE DRAWINGS

The above and other objects and features of the present invention will become apparent from the following description of the embodiments given in conjunction with the accompanying drawings, in which:

FIG. 1 is a configuration diagram of an apparatus for controlling scan of slave devices in accordance with an embodiment of the present invention;

FIG. 2 is a block diagram of an apparatus for controlling scan of slave devices in accordance with an embodiment of the present invention; and

FIG. 3 shows a flow chart illustrating a process of controlling scan of slave devices in accordance with an embodiment of the present invention.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions and/or constitutions will not be described in detail if they would unnecessarily obscure the features of the invention. Further, the terms to be described below are defined in consideration of their functions in the embodiments of the invention and may vary depending on a user's or operator's intention or practice. Accordingly, the definition may be made on a basis of the content throughout the specification.

Hereinafter, the embodiments of the present invention will be described in detail with reference to the accompanying drawings.

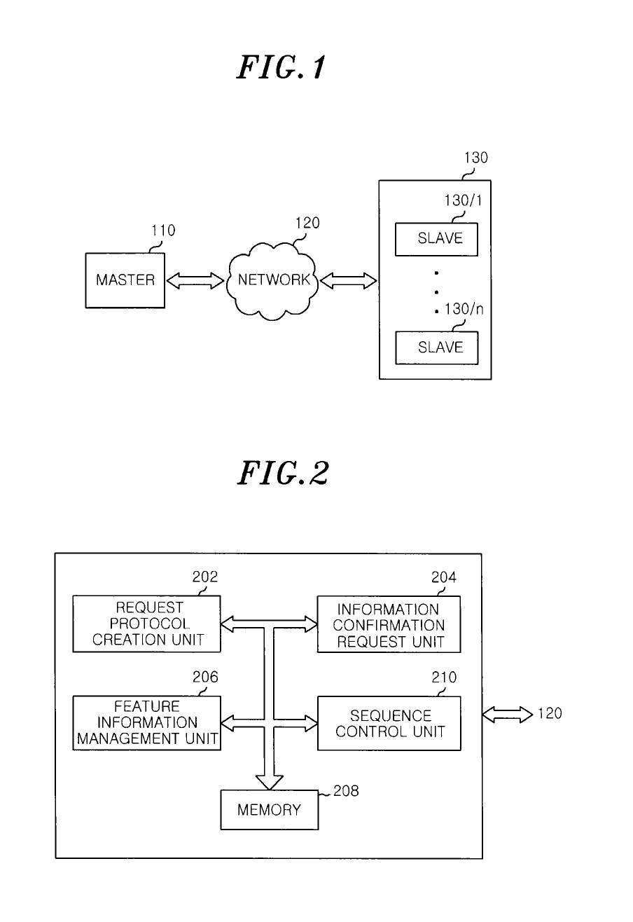

FIG. 1 is a configuration diagram of an apparatus for controlling scan of slave devices in accordance with an embodiment of the present invention, where the apparatus includes a master 110, a network 120 and a slave group 130 having a plurality of slaves 130/1-130/n.

Referring to FIG. 1, the master 110 may be configured to repeat a scan process as many as predefined N times (for example, three times), wherein the scan process is accomplished by the operations to create a request protocol for acquiring device feature information of each slave 130/1-130/n when a scan command is received from a user while the master 110 is in an operation mode after power is supplied to the system to complete initial startup; send (broadcast or multicast) the request protocol to each slave 130/1-130/n; acquire or collect the device feature information provided or by the salve 130/1-130/n in a unicast manner in response to the request protocol; send the received device feature information to the relevant slave to request confirmation when it is received from the each slave; and register the device feature information of the relevant slave as base information of the relevant slave when an acknowledgement for the confirmation request is received.

For instance, user's scan command for acquiring the device feature information may be carried out through the web or a specific GUI.

Scan process performed predefined N times (multiplexed scan) to acquire the device feature information of each slave 130/1-130/n aims to avoid fails in acquiring device feature information due to packet loss resulting from the unstable network 120 or processing overloads of the master (for example, caused when all device feature information received from slaves is not processed because there are too many slaves).

Also, the device feature information provided (sent) in a unicast manner by each slave 130/1-130/n to the master 110 may include slave IP, MAC, device ID, or the current state of the slave device.

Each slave 130/1-130/n in the slave group 130 may be configured to extract and send its device feature information to the master 110 in a unicast manner in response to a request protocol when the request protocol sent by the master 110 is received through the network 120 (that is, when a scan request is received); create and send an acknowledgement to the master 110 in response to a confirmation request sent by the master 110 when it is received through the network 120; and change its own state to a confirmed state after sending the acknowledgement.

Assuming the master 110 performs a scan process, for example, three times, one or more slaves that provide device feature information to the master 110 during a subsequent scan (a second scan) following a first scan may be slaves having not provided their device feature information during the first scan, or not sent an acknowledgement for the confirmation request by the master 110.

In addition, one or more slaves that provide device feature information to the master 110 during a third scan process after the second scan process may be slaves having not provided device feature information during the first and the second scan process, or not sent an acknowledgement to respond to the confirmation request by the master 110.

Just the slaves, for example, unresponsive slaves, having not sent device feature information to the master 110 when a second or third request protocol is received, or not sent an acknowledgement for the confirmation request send their device feature information to the master 110 through a unicast channel in response to the request protocol.

Each slave 130/1-130/n sends its device feature information to the master 110 and then an acknowledgement for the confirmation request to the master 110 to change its own state to a confirmed state. This change aims to make the slave not respond to a scan process or scan request when a second or third request protocol is received, that is, scan request is received, from the master 110.

For a scan process (a scan sequence) to acquire device feature information described above, the master 110 may include components shown in FIG. 2.

FIG. 2 is a block diagram of an apparatus for controlling scan of slave devices in accordance with an embodiment of the present invention, comprising a request protocol creation unit 202, an information confirmation request unit 204, a feature information management unit 206, a memory 208, and a sequence control unit 210.

First, the request protocol creation unit 202 may create a request protocol for acquiring device feature information of each slave 130/1-130/n when a scan command is received from a user while device power is turned-on and initial startup is then completed. The request protocol creation unit 202 may send the created request protocol in a unicast or multicast manner to each slave 130/1-130/n through a message sending/receiving unit (not shown).

Specifically, the request protocol creation unit 202 may create the request protocol predefined N times in sequence, for example, a first, a second and a third request protocol, in compliance with the control of the sequence control unit 210 described below to send it to the each slave 130/1-130/n through the message sending/receiving unit.

Next, upon acquiring or collecting the device feature information from each slave, the information confirmation request unit 204 may send device feature information acquired through the message sending/receiving unit (not shown) (that is, the device feature information sent by and received from the each slave in a unicast manner) to the relevant slave in response to the request protocol from the master and request confirmation thereof.

Also, the feature information management unit 206 may save or register the device feature information of the relevant slave (for example, slave IP, MAC, device ID, the current state of slave device) as base information of the relevant slave in the memory 208 when an acknowledgement for the confirmation request is received from each slave through the message sending/receiving unit.

The sequence control unit 210 may control scan process to repeat it as many as predefined N times, for example, three times, the scan process comprising: creating and sending a request protocol to each slave by the request protocol creation unit 202; sending a confirmation request to the each slave having sent the device feature information; and registering the device feature information of the each slave having sent an acknowledgement for the confirmation request as base information of the relevant slave. To this end, the sequence control unit 210 counts the number of scans whenever an acknowledgement is received from the slave, monitors or checks whether the count reaches the predefined N, and terminates or ends scan process (or sequence) for acquiring device feature information of each slave when the monitoring indicates that the count reaches the predefined N.

By the way, the apparatus for controlling scan of slave devices of the present invention may be applied to devices that require interworking with other devices through a network, for example, office automation systems, industrial control applications, and PA systems.

A method of acquiring device feature information from each slave by using an apparatus for controlling scan of slave devices in accordance with an embodiment of the present invention with the configuration described above is described in detail hereinbelow.

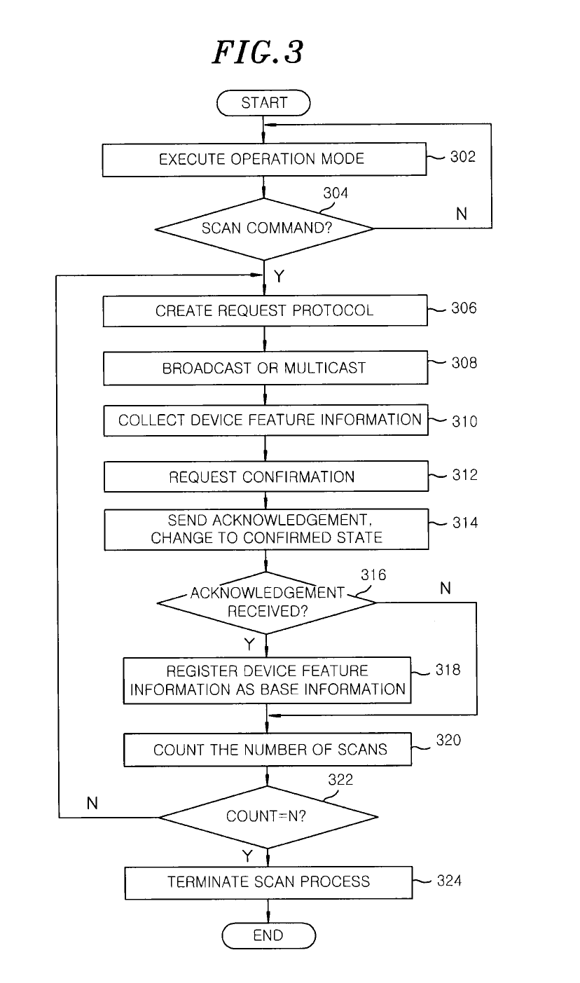

FIG. 3 shows a flow chart illustrating a method of controlling scan of slave devices in accordance with an embodiment of the present invention.

Referring to FIG. 3, the method begins with operations 302 and 304 where a scan command is received from a user while the master device is in its operation mode after device power is turned-on and initial startup is completed in compliance with the control of the sequence control unit 210. In response to the scan command, the request protocol creation unit 202 in the master 110 creates a request protocol for acquiring device feature information of each slave 130/1-130/n at operation 306. The request protocol creation unit 202 sends or transmits the created request protocol in a broadcast or multicast manner to each slave 130/1-130/n at operation 308.

In response to the request protocol, each slave 130/1-130/n extracts device feature information such as slave IP, MAC, device ID, the current state of slave device, when the request protocol is received from the master 110 through the network 120, and sends or transmits the device feature information to the master 110 through a unicast channel.

Next, when the master acquires or collects the device feature information from each slave through the message sending/receiving unit in response to the request protocol at operation 310, the information confirmation request unit 204 sends the acquired device feature information to the relevant slave and requests confirmation thereof at operation 312.

As a result of the operations described above, most slaves having sent the device feature information to the master 110 create and send an acknowledgement for the confirmation request to the master 110 through the network 120. The relevant slaves change their own state to the confirmed state after sending the acknowledgement at operation 314.

When the acknowledgement is received at operation 316, the feature information management unit 206 registers or saves the device feature information of the relevant slave of which the acknowledgement is received in the memory 208 as base information of the relevant slave at operation 318.

After that, the sequence control unit 210 counts the number of scans comprising sending a request protocol to each slave to collect device feature information, and requesting the relevant slave to confirm the information to receive an acknowledgement at operation 320. The sequence control unit 210 also checks or monitors if the count reaches the predefined N, e.g., three times at operation 322.

If the result of checking the count in operation 322 indicates that the count does not reach N, the method returns to operation 306 described above to repeat the operations following the operation 306. If the count reaches N, the sequence control unit 210 terminates or ends scan operation (or scan sequence) for acquiring device feature information of each slave at operation 324.

The explanation as set forth above is merely described a technical idea of the exemplary embodiments of the present invention, and it will be understood by those skilled in the art that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments.

Therefore, the scope of protection of the present invention should be construed as defined in the following claims and changes, modifications and equivalents that fall within the technical idea of the present invention are intended to be embraced by the scope of the claims of the present invention.

What is claimed is:

1. A method for controlling scan of slave devices, comprising:
requesting, by a master, each slave to provide its device feature information;
acquiring the device feature information provided by each slave in response to the request;
sending, by a master, the acquired device feature information to the relevant slave to request the slave to confirm the information;
registering the device feature information of the slave having sent an acknowledgement for the confirmation request as base information of the relevant slave; and
repeating a scan process performing the above operations described above for each slave predefined N times,
wherein the slave providing device feature information to the master during a subsequent scan after a first scan is a slave having not provided device feature information during the first scan, or not sent an acknowledgement for the confirmation request.

2. The method of claim 1, wherein said requesting each slave to provide its device feature information comprises requesting each slave to provide its device feature information when a scan command is received from a user while the master is in an operation mode.

3. The method of claim 1, wherein the request for device feature information is sent to the each slave in a broadcast or multicast manner.

4. The method of claim 1, wherein the slave having sent the acknowledgement to the master changes its own state to a confirmed state.

5. The method of claim 1, wherein the device feature information is sent from the each slave to the master in a unicast manner.

6. An apparatus for controlling scan of slave devices, which comprises:
a request protocol creation unit for creating and sending a request protocol for acquiring device feature information to each slave;
an information confirmation request unit for sending the acquired device feature information to a relevant slave to request confirmation when the device feature information is acquired from the each slave in response to the request protocol;
a feature information management unit for storing the device feature information of the slave for which an acknowledgement for the confirmation request is received in a memory as base information of the relevant slave; and a control unit for controlling a scan process by using the request protocol to repeat the scan process as many as predefined N times,
wherein the slave providing device feature information to a master during a subsequent scan after a first scan is a slave having not provided device feature information during the first scan, or not sent an acknowledgement for the confirmation request.

7. The apparatus of claim 6, wherein the request protocol creation unit creates and sends the request protocol to the each slave when a scan command is received from a user while the master is in an operation mode.

8. The apparatus of claim 6, wherein the request protocol is sent to the each slave in a broadcast or multicast manner.

9. The apparatus of claim 6, wherein the slave having sent the acknowledgement to the master changes its own state to a confirmed state.

10. The apparatus of claim 6, wherein the device feature information is sent in a unicast manner and received by the information confirmation request unit.

11. A method for controlling scan of slave devices, comprising:
requesting, by a master, each slave to provide its device feature information;
sending, by each slave, its device feature information to the master in response to the request;
sending, by a master, the acquired device feature information to the relevant slave to request confirmation;
changing, by each slave, its own state to a confirmed state after creating and sending an acknowledgement for the confirmation request to the master;
registering, by a master, the device feature information of the slave for which the acknowledgement for the confirmation request is received as base information of the relevant slave; and
repeating, by a master, scan operation from the step 1 to the step 5 for each slave as many as predefined N times, wherein the slave providing device feature information to the master during a subsequent scan after a first scan is a slave having not provided device feature information during the first scan, or not sent an acknowledgement for the confirmation request.

12. The method of claim 11, wherein the request for device feature information is sent to the each slave in a broadcast or multicast manner.

13. The method of claim 11, wherein the each slave sends the device feature information to the master in response to the request in a unicast manner.

14. An apparatus for controlling scan of slave devices, which comprises:
a master configured to repeat a scan process as many as predefined N times by operations of:
requesting each slave to provide device feature information; sending the received device feature information to a relevant slave when the device feature information is received to request confirmation; and
registering the device feature information of the relevant slave as base information of the relevant slave when an acknowledgement for the confirmation request is received; and
at least one or more slaves configured to:
provide, in response to the request, the device feature information to the master;
create an acknowledgement for the confirmation request to be sent to the master; and
change its own state to a confirmed state after sending the acknowledgement,
wherein the slave providing device feature information to the master during a subsequent scan after a first scan is a slave having not provided device feature information during the first scan, or not sent an acknowledgement for the confirmation request.

15. The apparatus of claim 14, wherein the master sends the request protocol to the each slave in a broadcast or multicast manner.

16. The apparatus of claim 14, wherein the at least one slave sends the device feature information to the master in a unicast manner.
